(19) United States
(12) Patent Application Publication
(10) Pub. No.: US 2009/0205679 A1
(43) Pub. Date: Aug. 20, 2009

(54) CUTTER BLADE CLEANING METHOD AND CUTTER BLADE CLEANING DEVICE, AS WELL AS ADHESIVE TAPE JOINING APPARATUS INCLUDING THE SAME

(76) Inventors: Masayuki Yamamoto, Osaka (JP); Yukitoshi Hase, Kameyama-shi (JP)

Correspondence Address: Cheng Law Group, PLLC, 1100 17th Street, N.W., Suite 503, Washington, DC, 20036, US

(21) Appl. No.: 12/368,228

(22) Filed: Feb. 9, 2009

(30) Foreign Application Priority Data
Feb. 15, 2008 (JP) 2008-034945

(51) Int. Cl. B08B 7/00; B08B 1/00

(52) U.S. Cl. 134/6; 15/93.1

(57) ABSTRACT

A cutter blade cuts an adhesive tape and then returns to its standby position. Thereafter, a cleaning unit moves to a position below the cutter blade, and the cutter blade moves downward to a predetermined height. Herein, a cleaning member impregnated with a wash liquid is pierced with the cutter blade in order to clean an adherent on the cutter blade. Each time the cutter blade cleaning process is executed, the pierced position of the cleaning member with the cutter blade is changed.

### BACKGROUND OF THE INVENTION

(1) Field of the Invention

The present invention relates to a cutter blade cleaning method and a cutter blade cleaning device each used for cleaning a cutter blade that cuts out a protective adhesive tape, which is joined to a surface of a substrate such as a semiconductor wafer or a glass substrate, along a contour of the substrate, as well as an adhesive tape joining apparatus including the same.

(2) Description of the Related Art

Conventionally, a surface-protective adhesive tape has been joined to a surface of a semiconductor wafer (hereinafter, appropriately referred to as a “wafer”) and then has been cut in accordance with the following method. That is, the adhesive tape is supplied onto the front face of the wafer which is placed on and held by a chuck table. Next, a joining roller rolls on the adhesive tape to join the adhesive tape to the surface of the wafer. Next, a cutter blade travels along an outer periphery of the wafer while piercing through the adhesive tape. Alternatively, the cutter blade relatively travels along the outer periphery of the wafer in conjunction with rotation of the chuck table. There is known a method in which a protective tape is cut along an outer periphery of a wafer using this method (refer to JP 2006-015453 A and JP 2004-025438 A).

Occasionally, when the cutter blade cuts the adhesive tape along the outer periphery of the wafer, an adhesive of the adhesive tape adheres to and is left on the cutter blade. Consequently, the cutter blade is degraded in cutting performance due to deposition of this adherent, leading to poor finishing of a section of the adhesive tape. In order to avoid this disadvantage, conventionally, the adherent has been manually wiped out from the cutter blade when the finishing of the section of the adhesive tape becomes poor. Alternatively, the adherent has been manually wiped off from the cutter blade at regular intervals. Then, a release agent has been applied to the cutter blade in order to prevent the adhesive from adhering to the cutter blade.

However, the manual maintenance for the cutter blade requires time and effort, and inevitably interrupts the continuous process of joining the adhesive tape to the wafer. Consequently, this manual maintenance causes deterioration of working efficiency.

### SUMMARY OF THE INVENTION

An object of the present invention is to efficiently clean a cutter blade in order to allow long-term use of the cutter blade.

In order to accomplish the object described above, the present invention adopts the following configuration:

A cutter blade cleaning method for cleaning a cutter blade that cuts out an adhesive tape, which is joined to a substrate, along a contour of the substrate,

the cutter blade cleaning method including the step of

executing a process of cleaning an adherent from the cutter blade while displacing a pierced position of a cleaning member with the cutter blade.

According to the cutter blade cleaning method of the present invention, the cleaning member is pierced with the cutter blade. Therefore, the adherent such as an adhesive, which adheres to the cutter blade, can be wiped out by the cleaning member. Alternatively, the adherent can be lifted up to an upper position out of a cutting operation position of a nose of the cutter blade. After the cleaning, no foreign matter such as the adhesive adheres to the cutter blade, so that the cutter blade can cut the adhesive tape with good accuracy. Moreover, the cutter blade is applied with no excess stress due to frictional resistance, leading to suppression of chipping of the nose, and the like. As a result, a single cutter blade can be used for a long period of time.

Moreover, each time the cleaning member is pierced with the cutter blade, the pierced position of the cleaning member is displaced. For this reason, there is no possibility that the adherent, which has been wiped out by the cleaning member in the preceding cutter blade cleaning process, adheres to the cutter blade again. Accordingly, every cleaning process can be suitably performed.

In the above cutter blade cleaning method, preferably, each time the cleaning member is pierced with the cutter blade, the piercing depth is gradually made shallow.

According to this method, the adherent, which is not wiped out completely and is left on the cutter blade, is lifted up above the cutting position of the cutter blade in the tape cutting process to be executed subsequently. Accordingly, the adhesive tape can be cut by the cutter blade having a cutting edge which is cleaned constantly.

For example, the cleaning member is impregnated with a wash liquid.

When the cleaning member is pierced with the cutter blade, the wash liquid with which the cleaning member is impregnated melts or softens the adherent such as the adhesive adhering to the cutter blade. Thus, the softened adherent can be wiped out or can be lifted up to the upper position out of the cutting operation position of the nose.

For example, the wash liquid to be used herein has a releasing property for anti-adhesion.

When the cleaning member is pierced with the cutter blade to remove the adherent from the cutter blade, the wash liquid having the releasing property is applied to the cutting edge. Accordingly, the subsequent tape cutting process can be executed in a state where an adhesive hardly adheres to the cutter blade by virtue of the releasing property of the wash liquid.

Preferably, the cutter blade pierces through a first cleaning member impregnated with a wash liquid and then pierces through a second cleaning member impregnated with a release agent for anti-adhesion.

This case allows optionally combined use of a wash liquid which is used in accordance with a physical property of an adhesive of an adhesive tape and a release agent which is excellent in anti-adhesion performance. Accordingly, the process of cleaning the cutter blade and the process of suppressing adhesion of the adherent can be executed suitably.

Preferably, the adherent adhering to the cutter blade is monitored by a surveillance sensor. Also preferably, when the adherent adhering to the cutter blade is detected by the surveillance sensor, the cleaning member is pierced with the cutter blade newly and the pierced position of the cleaning member with the cutter blade is displaced.

The surveillance sensor detects the adherent adhering to the cutter blade or a time when an amount of the adherent exceeds a predetermined amount. Thus, the surveillance sensor allows an operator to recognize a timing of executing the cutter blade cleaning process. Accordingly, there is no possibility that the cutter blade cleaning process is executed though no adherent adheres to the cutter blade or the adherent adheres to the cutter blade to a degree that the cutter blade can cut the adhesive tape without problems. Thus, the cutter blade cleaning process is executed at a minimum frequency and the tape cutting process is executed constantly in a favorable state.

Moreover, the monitoring is performed continuously immediately after completion of the cutter blade piercing and cleaning processes, so that the operator can recognize an amount of the adherent left on the cutter blade. If the cleaning is unsatisfactory, the cutter blade cleaning process can be executed again. Accordingly, the subsequent tape cutting process can be suitably executed in a state where no adherent adheres to the cutter blade.

In order to accomplish the object described above, the present invention also adopts the following configuration:

A cutter blade cleaning device for cleaning a cutter blade that cuts out an adhesive tape, which is joined to a substrate, along a contour of the substrate,

the cutter blade cleaning device including:

the cutter blade that is disposed so as to move liftably between an upper retracted position and a lower cutting operation position; and

a cleaning member that moves between a cleaning position on a liftable movement path of the cutter blade and a receded position out of the liftable movement path, wherein

the cleaning member and the cutter blade are moved relatively such that a pierced position of the cleaning member with the cutter blade is displaced.

With the cutter blade cleaning device of the present invention, the foregoing cutter blade cleaning method can be implemented suitably.

Preferably, the cutter blade cleaning device is configured as follows.

For example, the cleaning member can rotate about the pierced position thereof with the cutter blade, with the pierced position being defined as a starting point.

With this configuration, for example, the cleaning member can be reduced in size as compared with a device that moves the cleaning member linearly in order to change the pierced position thereof with the cutter blade.

The cutter blade cleaning device further includes a ratchet type pitch feed device for allowing the cleaning member to rotate at a predetermined angle in conjunction with the movement of the cleaning member from the cleaning position to the receded position.

With this configuration, the cleaning member can be rotated in a pitch feeding manner without an actuator for pitch feed such as a motor. Accordingly, the cutter blade cleaning device can be implemented at low cost.

The cutter blade cleaning device further includes a container that is divided into two segments by a partition wall. Herein, a first segment of the container houses a cleaning member impregnated with a wash liquid while a second segment of the container houses a cleaning member impregnated with a liquid having a releasing property.

With this configuration, both the wash of the cutter blade and the maintenance for the cutter blade can be performed.

Preferably, the cutter blade cleaning device further includes: a sensor that detects a liquid surface level of a wash liquid retained in a container in which the cleaning member is housed while being impregnated with the wash liquid; a calculation device for comparing an actually measured value of the detected liquid surface level with a predetermined reference value; and an informing device for providing information when the actually measured value falls below the reference value as a result of the comparison between the actually measured value and the reference value.

With this configuration, the consumption of the wash liquid by the impregnation is detected based on the liquid surface level of the wash liquid in the container, so that the operator readily recognizes a timing of refilling the container with the wash liquid. Accordingly, there is no possibility that the cutter blade cleaning process is executed in a low wash liquid state that the cleaning member is not entirely impregnated with the wash liquid.

In order to accomplish the object described above, the present invention also adopts the following configuration:

An adhesive tape joining apparatus including:

a chuck table that holds a substrate placed thereon;

a tape supply device for supplying a surface-protective adhesive tape above the substrate placed on and held by the chuck table, with an adhesive surface of the adhesive tape being directed downward;

a joining roller that rolls on the adhesive tape while pressing the adhesive tape against the substrate to join the adhesive tape to the substrate;

a tape cutting device that allows a cutter blade, which moves liftably, to relatively travel along an outer periphery of the substrate in a state where the adhesive tape joined to the substrate is pierced with the cutter blade;

a separation roller that separates an unnecessary tape occurring from the tape cutting and collects the unnecessary tape; and

a cleaning member that moves between a cleaning position on a liftable movement path of the cutter blade and a receded position out of the liftable movement path, wherein the cleaning member and the cutter blade are moved relatively such that the pierced position of the cleaning member with the cutter blade is displaced.

With this configuration, the process of joining the adhesive tape to the substrate, the process of cutting the adhesive tape along the outer periphery of the substrate, and the process of collecting the unnecessary tape can be efficiently executed in succession. Further, the process of cleaning the cutter blade can be executed without burdensome manual operation. That is, the adhesive tape can be cut by the cutter blade in a state where no adherent adheres to a cutting edge of the cutter blade constantly. Moreover, the cut adhesive tape has a smooth section having no irregularities.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a perspective view showing a general configuration of an adhesive tape joining apparatus;

FIG. 2 is a side view showing a general configuration of a tape cutting device;

FIG. 3 is a perspective view showing main components of the tape cutting device;

FIG. 4 is a plan view of a cutter unit;

FIG. 5 is a longitudinal sectional front view of a portion of the cutter unit;

FIG. 6 is a side view showing main components of the tape cutting device when an adhesive tape is pierced with a cutter blade;

FIG. 7 is a side view showing the main components of the tape cutting device in a state where the cutter blade is brought into contact with an outer peripheral edge of a wafer;

FIGS. 8 to 11 are front views each showing an adhesive tape joining process;

FIG. 12 is a side view of a cutter blade cleaning device;

FIG. 13 is a plan view of the cutter blade cleaning device at a receded and standby position;

FIG. 14 is a plan view of the cutter blade cleaning device at a cleaning position;

FIG. 15 is a plan view of a cleaning unit;

FIG. 16 is a partially notched side view of the cleaning unit;

FIG. 17 is a plan view showing main components of the cutter blade cleaning device in a state where rotation of a cleaning member in a pitch feeding manner is started;

FIG. 18 is a plan view showing the main components of the cutter blade cleaning device in a state where the rotation of the cleaning member in the pitch feeding manner is ended;

FIG. 19 is a partially notched side view showing another cleaning unit; and

FIG. 20 is a side view showing another cutter blade cleaning device.

### DESCRIPTION OF THE PREFERRED EMBODIMENTS

With reference to the drawings, hereinafter, description will be given of preferred embodiments of the present invention.

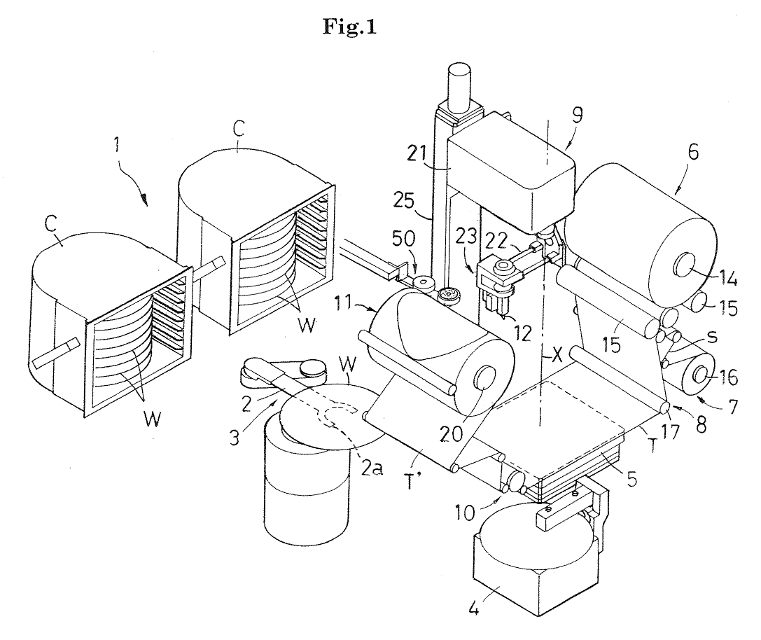

FIG. 1 is a perspective view showing a general configuration of a protective tape joining apparatus as one example of an adhesive tape joining apparatus.

This protective tape (adhesive tape) joining apparatus includes: a wafer supply/collection part 1 with a cassette C mounted therein that houses a semiconductor wafer (hereinafter, simply referred to as a “wafer”) W as one example of a substrate; a wafer transport mechanism 3 that has a robot arm 2; an alignment stage 4; a chuck table 5 that suction-holds the wafer W placed thereon; a tape supply part 6 that supplies a surface-protective adhesive tape T provided with a separator s onto a position above the wafer W; a separator collection part 7 that separates the separator s from the adhesive tape T supplied from the tape supply part 6 and collects the separator s; a joining unit 8 that joins the adhesive tape T to the wafer W placed on and suction-held by the chuck table 5; a tape cutting device 9 that cuts out the adhesive tape T joined to the wafer W along a contour of the wafer W; a separation unit 10 that separates an unnecessary tape T′ occurring after joining to the wafer W and cutting the adhesive tape; a tape collection part 11 that winds and collects the unnecessary tape T′ separated by the separation unit 10; and others. Hereinafter, description will be given of detailed configurations of the respective structural parts and mechanisms.

The wafer supply/collection part 1 has two cassettes C mounted therein with being arranged in parallel. A plurality of wafers W are inserted into and housed in each cassette C in a stack mannerin a state where each wafer W is housed in a horizontal attitude with a wiring pattern face (a surface) thereof being directed upward.

The robot arm 2 of the wafer transport mechanism 3 can move forward and backward horizontally. Moreover, the entire robot arm 2 is driven to turn and move liftably. A wafer holding part 2a is provided at a tip end of the robot arm 2. The wafer holding part 2a is formed into a horseshoe shape and is of a vacuum-suction type. That is, the wafer holding part 2a is inserted between the stacked wafers W housed in the cassette C, and suction-holds the wafer W from a back face of the wafer W. The robot arm 2 pulls out the suction-held wafer W from the cassette C, and transports the wafer W to the alignment stage 4, the chuck table 5 and the wafer supply/collection part 1 in turn.

When the wafer transport mechanism 3 transports the wafer W to the alignment stage 4 and places the wafer W on the alignment stage 4, the alignment stage 4 performs alignment on the wafer W, based on a notch or an orientation flat formed at an outer periphery of the wafer W.

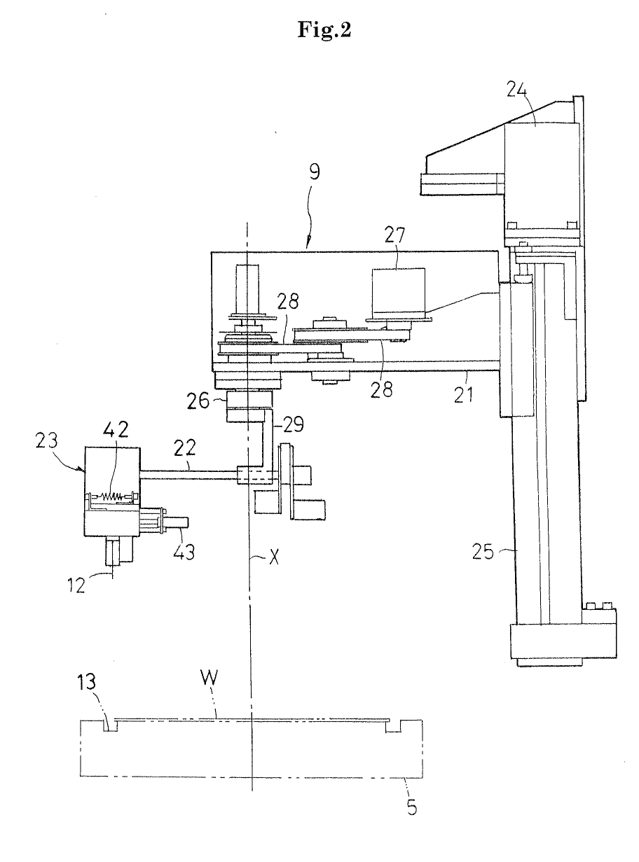

When the wafer transport mechanism 3 transfers the wafer W from the alignment stage 4 to the chuck table 5 and places the wafer W on the chuck table 5 in a predetermined alignment attitude, the chuck table 5 sucks the wafer W by vacuum. As shown in FIG. 2, moreover, a cutter traveling groove 13 is formed on a top face of the chuck table 5. The cutter traveling groove 13 allows a cutter blade 12 of the adhesive tape cutting device 9 (to be described later) to travel along the contour of the wafer W and to cut the adhesive tape T.

The tape supply part 6 has the following configuration. That is, the adhesive tape T provided with the separator s is fed out from a supply bobbin 14, and then is guided to and wound around a group of guide rollers 15. When being separated from the separator s, the adhesive tape T is guided to the joining unit 8. Herein, the supply bobbin 14 is applied with appropriate resistance against its rotation in order to prevent the adhesive tape T from being fed out excessively.

The separator collection part 7 has the following configuration. That is, a collection bobbin 16 is driven to rotate in a winding direction in order to wind the separator s separated from the adhesive tape T.

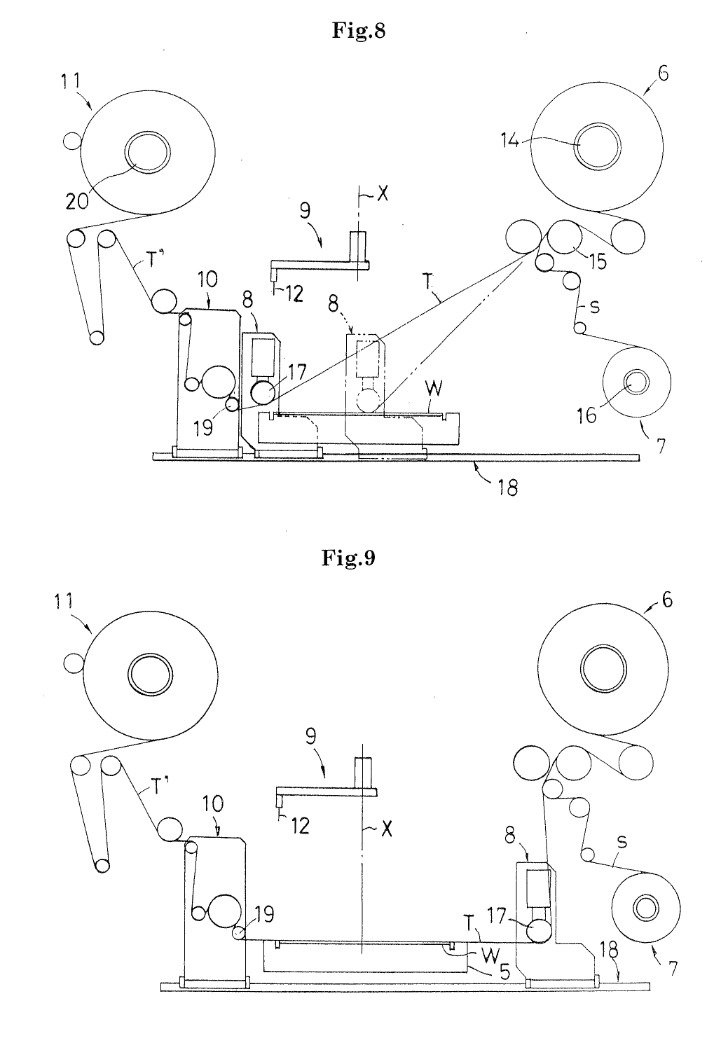

As shown in FIG. 8, a joining roller 17 is provided horizontally on the joining unit 8 so as to be oriented forward. The joining roller 17 is driven by a slide guide mechanism 18 and a screw-feed type drive mechanism (not shown) to reciprocate horizontally.

Moreover, a separation roller 19 is provided horizontally in the separation unit 10 so as to be oriented forward. The separation roller 19 is also driven by the slide guide mechanism 18 and the screw-feed type drive mechanism (not shown) to reciprocate horizontally.

In the tape collection part 11, a collection bobbin 20 rotates in a winding direction in order to wind the unnecessary tape T′.

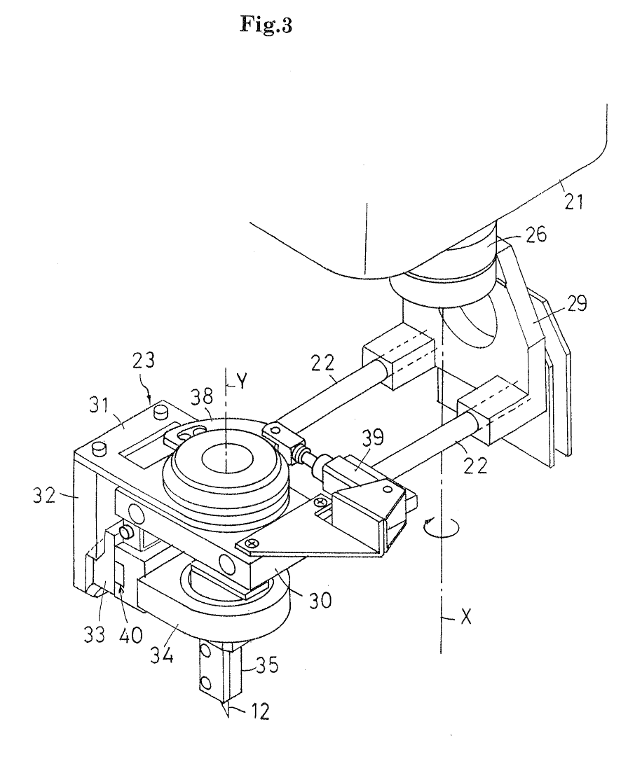

As shown in FIGS. 2 and 3, the tape cutting device 9 has the following configuration. That is, a pair of support arms 22 are arranged in parallel at a lower side of a liftably moving table 21 capable of moving liftably. The pair of support arms 22 can turn about a vertical axis X positioned at a center of the chuck table 5. A cutter unit 23 is provided at each free end of the support arm 22, and the cutter blade 12 is attached to the cutter unit 23 with a nose thereof being directed downward. More specifically, when the support arm 22 turns about the vertical axis X, the cutter blade 12 travels along the outer periphery of the wafer W to cut out the adhesive tape T.

The liftably moving table 21 moves liftably along an upright frame 25 in a screw-feed manner when a motor 24 rotates forward/backward. A rotation shaft 26 is attached to a free end of the liftably moving table 21 so as to rotate about the vertical axis X and a motor 27 is provided on the liftably moving table 21. The rotation shaft 26 is interlocked with the motor 27 through two belts 28 such that a rotation speed thereof is reduced. In other words, when the motor 27 is actuated, the rotation shaft 26 rotates in a predetermined direction. Further, a support member 29 extends downward from the rotation shaft 26, and the support arm 22 is supported at a lower end of the support member 29 so as to pass through the support member 29. Herein, the support arm 22 can slide horizontally. Accordingly, when the support arm 22 slides horizontally, a length from the vertical axis X to the cutter blade 12 can be changed. In other words, a turning radius of the cutter blade 12 can be adjusted and changed in accordance with a diameter of a wafer.

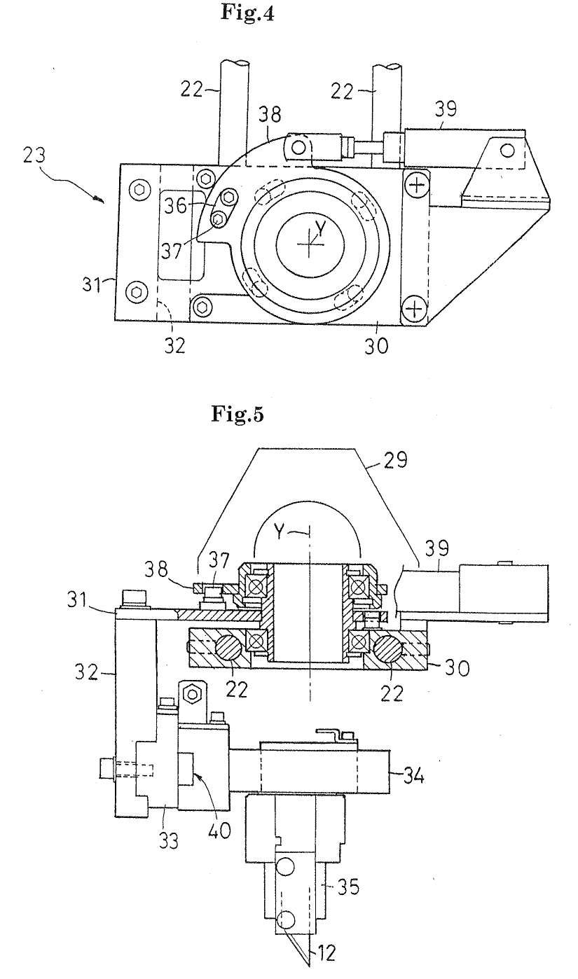

As shown in FIGS. 3 to 5, a bracket 30 is fixedly attached to the free end of the support arm 22. The cutter unit 23 is attached to and supported by the bracket 30. The cutter unit 23 includes a turning member 31 supported by the bracket 30 so as to turn about a vertical axis Y within a predetermined range, an upright wall-shaped support bracket 32 coupled to a bottom face of an end of the turning member 31, a cutter support member 33 coupled to a side face of the support bracket 32, a bracket 34 supported by the cutter support member 33, a cutter holder 35 attached to the bracket 34, and the like. Herein, the cutter blade 12 is fastened to and fixed on a side face of the cutter holder 35 so as to be exchangeable with new one.

Herein, an operation flange 38 is provided above the turning member 31 and turns together with the turning member 31 by engagement of an oval hole 36 with a protrusion 37. The operation flange 38 turns by means of an air cylinder 39, so that the attitude of the entire cutter unit 23 is changed about the vertical axis Y, with respect to the support arm 22. That is, the actuation of the air cylinder 39 allows adjustment of an angle (a cutting angle) of the cutter blade 12 with respect to the moving direction within a predetermined range.

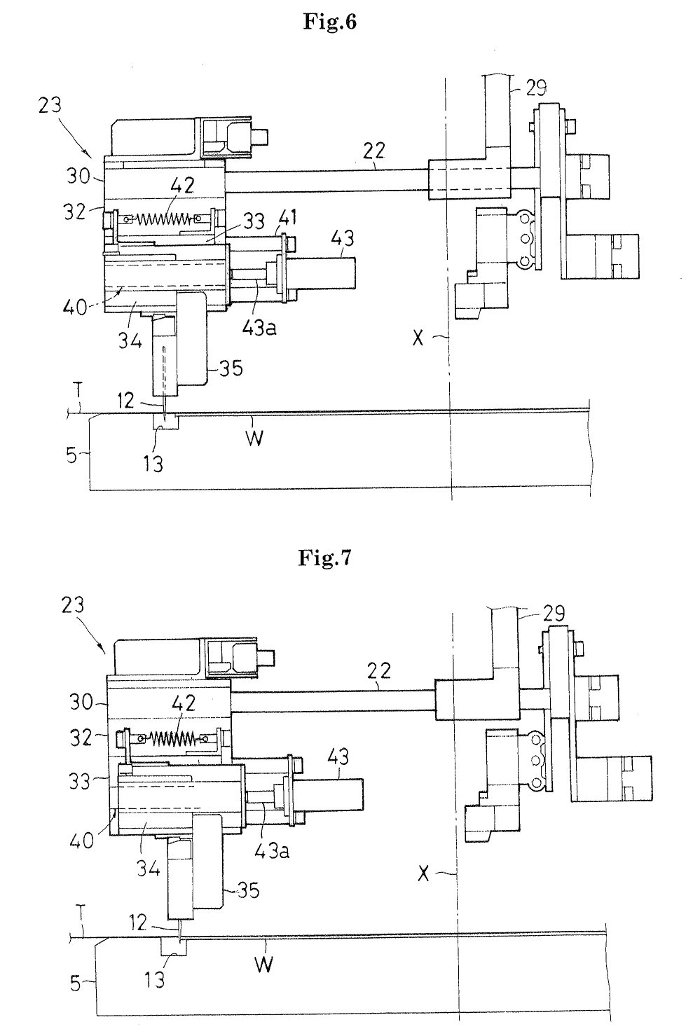

The bracket 34 is supported against the cutter support member 33 so as to slide linearly in a longitudinal direction (a front/back direction of a plane of FIG. 5) of the support arm 22 through a guide rail mechanism 40. A spring 42 is provided between the cutter support member 33 and the bracket 34 with tension being applied thereto. As shown in FIG. 6, an elastic restoring force of the spring 42 allows the bracket 34 to slide in a direction so as to approach the vertical axis (the turning center) X.

An air cylinder 43 is fixedly provided at a turning center of the cutter support member 33 through a stator 41 along the sliding direction of the bracket 34. The air cylinder 43 has a piston rod 43a provided so as to come into contact with an end face of the bracket 34.

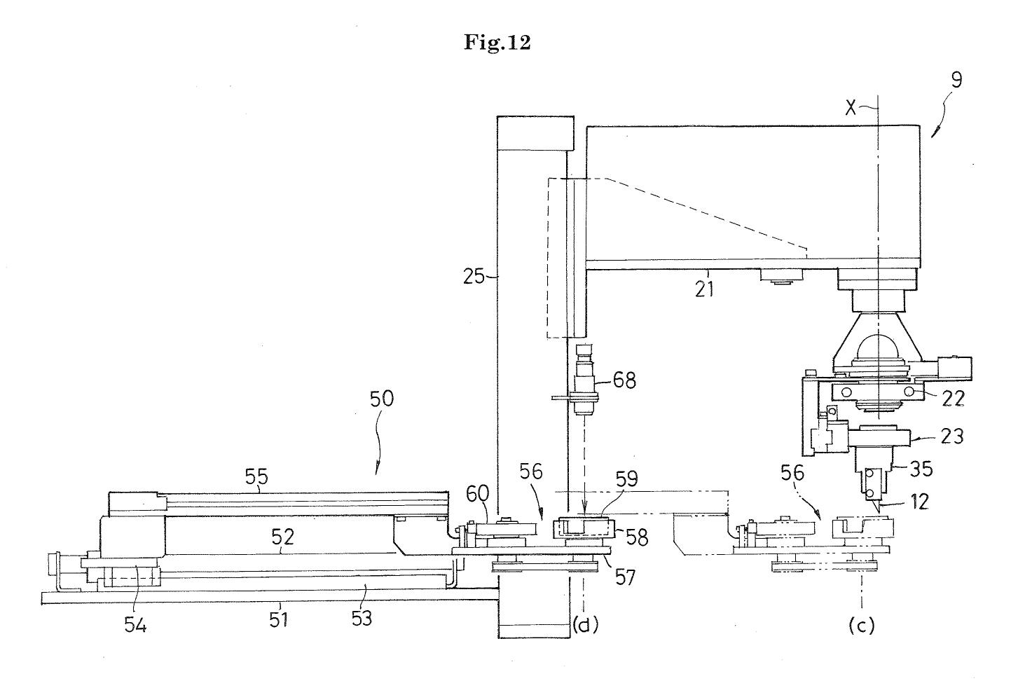

As shown in FIGS. 12 to 14, the tape cutting device 9 includes a cutter blade cleaning device 50 that removes an adhesive and the like from the cutter blade 12.

The cutter blade cleaning device 50 includes a base 51, a rodless cylinder 52, a movable table 54, a support arm 55, a cleaning unit 56 and the like. Herein, the base 51 is provided horizontally at a lower back side of the upright frame 25 so as to be oriented in a direction that the liftably moving table 21 protrudes (hereinafter, referred to as a “forward direction”) and in an opposite direction (hereinafter, referred to as a “backward direction”). The rodless cylinder 52 is provided horizontally on the base 51 so as to be oriented longitudinally. The movable table 54 is coupled to the rodless cylinder 52 and reciprocates longitudinally along a guide rail 53 on the base 51. The support arm 55 is coupled to and supported by the movable table 54 and extends forward in a horizontal cantilever manner. The cleaning unit 56 is provided at a tip end of the support arm 55.

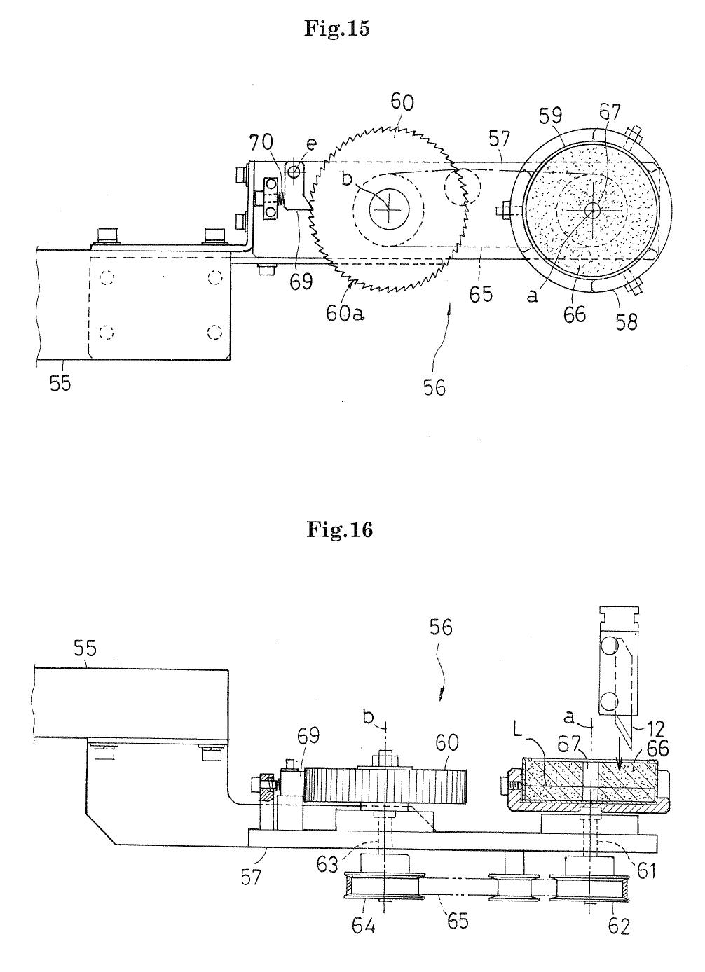

As shown in FIGS. 15 and 16, the cleaning unit 56 includes a support bracket 57, a rotation table 58, a container 59, a ratchet wheel 60 and the like. Herein, the support bracket 57 is coupled to a front end of the support arm 55. The rotation board 58 is pivotally supported at a front side of the support bracket 57 so as to rotate about a vertical axis a. The container 59 is formed into a circular cup shape, is fitted into the rotation table 58 from above, and is fastened to the rotation table 58 with a screw. The ratchet wheel 60 is pivotally supported at a rear side of the support bracket 57 so as to rotate about a vertical axis b. Moreover, a non-slip type belt 65 is wound between a pulley 62 coupled to a support shaft 61 of the rotation table 58 and a pulley 64 coupled to a support shaft 63 of the ratchet wheel 60, with tension being applied thereto.

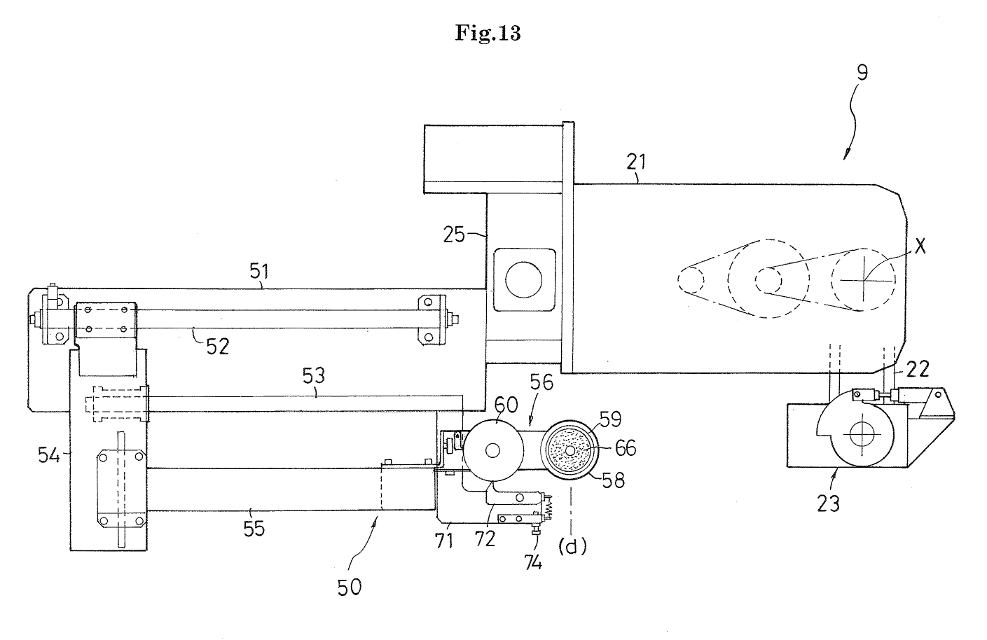

As shown in FIGS. 12 to 14, when the movable table 54 moves forward to a terminal, the container 59 is located at a cleaning position (c) on a liftable movement path of the cutter blade 12 located at an upper retracted position. As shown in FIGS. 12 and 13, moreover, when the movable board 54 moves backward, the container 59 is located at a receded and standby position (d) out of the movable movement path of the cutter blade 12 in the backward direction in such a manner that a longitudinal movement stroke of the movable board 54 is set.

As shown in FIGS. 15 and 16, the container 59 retains a wash liquid and houses a cleaning member 66 made of a porous material, such as a sponge. The cleaning member 66 is evenly impregnated with the wash liquid in a predetermined amount, by a capillary phenomenon. Herein, a through hole 67 is formed at a center of the cleaning member 66 so as to liftably penetrate through the cleaning member 66, so that a liquid surface level of the wash liquid can be seen from the through hole 67.

The container 59, which is located at the cleaning position (c), has a center deviating from the liftable movement path of the cutter blade 12. In other words, the cleaning member 66 is pierced with the cutter blade 12, which moves downward, at a position other than the through hole 67.

A reflective sensor 68 is fixedly provided at a position immediately above the container 59 located at the receded and standby position (d), and detects a distance to a target through use of a laser beam. The sensor 68 emits the laser beam to the center of the cleaning member 66 in the container 59 located at the receded and standby position (d) to detect the liquid surface level L of the wash liquid in the through hole 67.

An inversion preventing claw 69 is provided at a rear side of the support bracket 57. Herein, the inversion preventing claw 69 is engaged with a ratchet 60a in the rim of the ratchet wheel 60, turns about an axis e, and is biased in an engaging direction by a spring 70. In FIG. 15, accordingly, this configuration permits only counterclockwise rotation of the ratchet wheel 60.

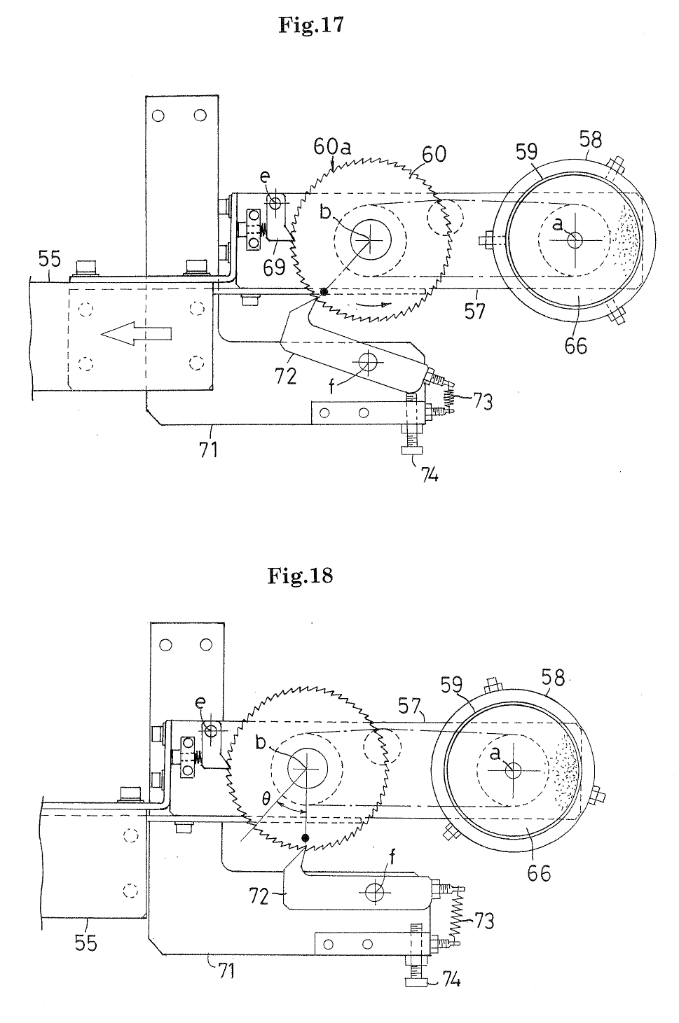

As shown in FIG. 17, a fixed table 71, which is formed into an “L” shape when being viewed in a plane, is coupled to a front side of the base 51. Moreover, a feed claw 72, which is opposite to the ratchet 60a in the rim of the ratchet wheel 60, is pivotally supported by and coupled to an end of the fixed table 71 so as to swing about a vertical axis f. Herein, the feed claw 72 is biased by a spring 73 to swing toward a direction in engagement with the ratchet wheel 60, and is brought into abutment with a stopper bolt 74 for adjustment of the swinging direction thereof under the bias of the spring 73.

The ratchet wheel 60 is rotated in a pitch feeding manner as follows in conjunction with the longitudinal reciprocation of the cleaning unit 56. This rotation allows the cleaning member 66 in the container 59 to rotate forward while rotating in a certain direction.

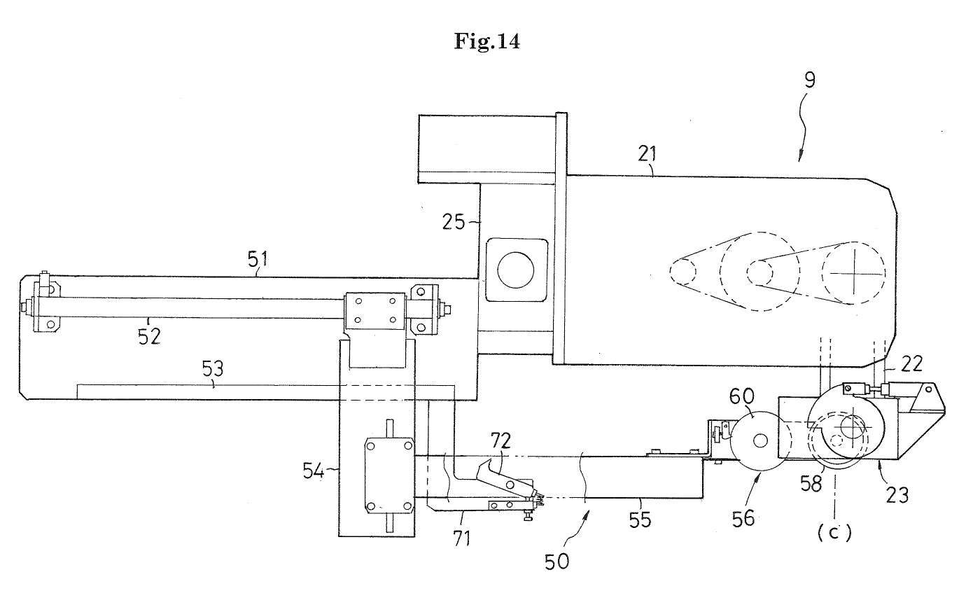

As shown in FIG. 14, more specifically, when the cleaning unit 56 moves forward such that the container 59 is located at the cleaning position (c), the ratchet wheel 60 is distant from the feed claw 72. Herein, the ratchet wheel 60 is engaged with the inversion preventing claw 69 and, therefore, is maintained at a predetermined rotation attitude.

In this case, the feed claw 72 in a free state is biased to swing into an attitude where the stopper bolt 74 comes into abutment with the feed claw 72, and a tip end thereof is on a longitudinal movement path of the ratchet wheel 60. That is, the feed claw 72 is in a waiting attitude.

As shown in FIG. 17, when the cleaning unit 56 moves backward such that the container 59 moves backward from the cleaning position (c), the ratchet 60a in the rim of the ratchet wheel 60 is engaged with the tip end of the feed claw 72 in the waiting attitude immediately before the container 59 arrives at the receded and standby position (d). In this state, when the cleaning unit 56 further moves backward, the ratchet wheel 60 engaged with the feed claw 72 relatively receives a rotation force. Thus, the ratchet wheel 60 climbs over the swung inversion preventing claw 69 and then is rotated in a predetermined direction (a counterclockwise direction in FIG. 17).

In the state where the cleaning unit 56 moves backward to the receded position (d) as shown in FIG. 13, the ratchet wheel 60 is rotated at a predetermined feed angle 0 before starting of the backward movement as shown in FIG. 18. In conjunction with this rotation, the container 59 is rotated in the same direction at the same angle. As described above, each time the cleaning unit 56 moves backward from the cleaning position (c) to the receded and standby position (d), the container 59 is moved in the pitch feeding manner. Herein, as the tip end of the feed claw 72 in the waiting attitude approaches the axis b of the ratchet wheel 60 in such a manner that a protruding amount of the stopper bolt 74 is decreased, the feed angle θ at the time when the cleaning unit 56 arrives at the receded and standby position (d) can be increased. Conversely, as the tip end of the feed claw 72 in the waiting attitude is spaced away from the axis b in such a manner that the protruding amount of the stopper bolt 74 is increased, the feed angle θ at the time when the cleaning unit 56 arrives at the receded and standby position (d) can be decreased.

With reference to FIGS. 8 to 11, next, description will be given of a series of operations for joining the adhesive tape T to the surface of the wafer W and then cutting the adhesive tape T with the adhesive tape joining apparatus according to the present invention.

Upon reception of a command to join the adhesive tape T, first, the robot arm 2 of the wafer transport mechanism 3 moves toward the cassette C mounted on a cassette table, and the wafer holding part 2a is inserted between the wafers W housed in the cassette C. The wafer holding part 2a suction-holds the wafer W from below (i.e., from the back face of the wafer W), pulls out the wafer W from the cassette C, and moves to mount the wafer W to the alignment stage 4.

The alignment stage 4 performs the alignment on the wafer W placed thereon, through use of the notch formed at the outer periphery of the wafer W. Thereafter, the robot arm 2 transfers the wafer W subjected to the alignment from the alignment stage 4 to the chuck table 5, and places the wafer W on the chuck table 5.

The chuck table 5 suction-holds the wafer W placed thereon in a state where the center of the wafer W is located at the center of the chuck table 5. As shown in FIG. 8, herein, the joining unit 8 and the separation unit 10 are in an initial position on the left side, respectively. Moreover, the cutter blade 12 of the tape cutting device 9 is in an initial position on the upper side.

As shown by an imaginary line in FIG. 8, next, the joining roller 17 of the joining unit 8 moves downward. Then, the joining roller 17 rolls on the wafer W in the forward direction (the right direction in FIG. 8) while pressing the adhesive tape T downward against the wafer W. Thus, the adhesive tape T is joined to the entire surface of the wafer W and the top face of the chuck table 5.

As shown in FIG. 9, when the joining unit 8 arrives at a terminal position, the cutter blade 12 moves downward, so that the adhesive tape T on the cutter traveling groove 13 of the chuck table 5 is pierced with the cutter blade 12.

As shown in FIG. 6, in this case, high-pressure air is supplied into the air cylinder 43, so that the piston rod 43a protrudes largely. Accordingly, the bracket 34 slides to an outward stroke end against the spring 42. Herein, the adhesive tape T is pierced with the cutter blade 12 at a position where the cutter blade 12 is spaced away from an outer peripheral edge of the wafer W slightly(by several millimeters.) Thereafter, the air pressure in the air cylinder 43 is reduced such that the protruding force of the piston rod 43a becomes smaller than the biasing force of the spring 42. As shown in FIG. 7, then, the bracket 34 slides in such a manner that spring 42 presses and biases the bracket 34. Thus, the nose of the cutter blade 12 is pressed against the outer peripheral edge of the wafer W at an appropriate contact pressure.

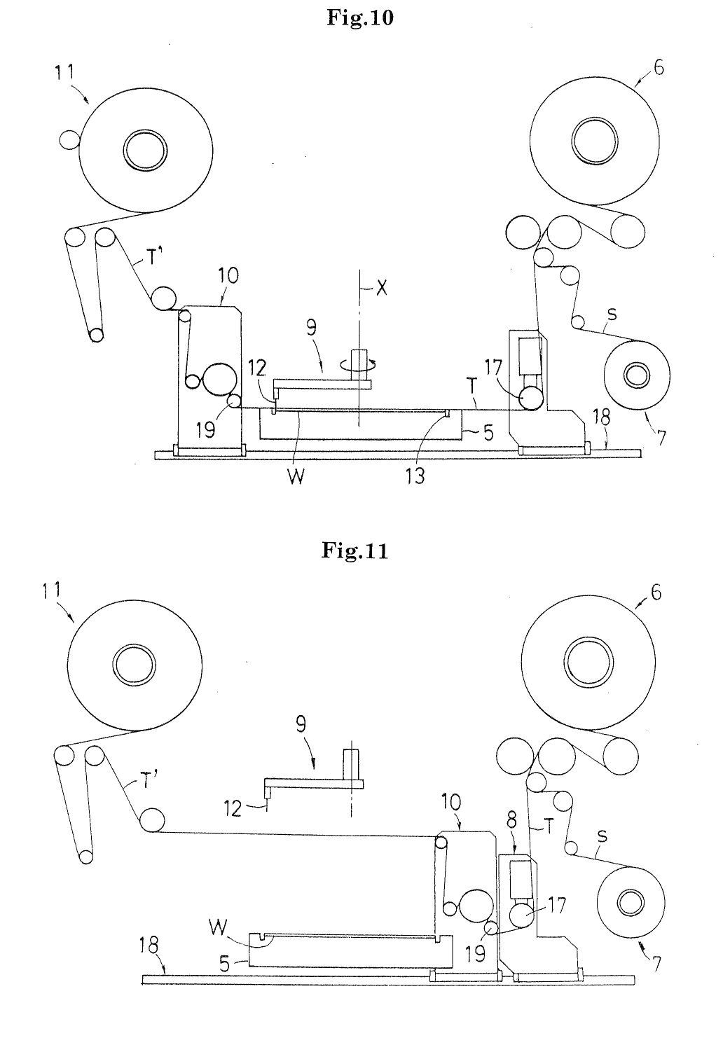

When the operation of pressing the cutter blade 12 against the outer peripheral edge of the wafer W is completed at a cutting start position, the support arm 22 turns as shown in FIG. 10. This turn allows the cutter blade 12 to turn while coming into sliding contact with the outer peripheral edge of the wafer W, so that the adhesive tape T is cut along the outer periphery of the wafer W.

When the operation of cutting the adhesive tape T along the outer periphery of the wafer W is completed, the cutter blade 12 moves upward and returns to the original standby position as shown in FIG. 11. Next, the separation unit 10 moves forward to separate the remained unnecessary tape T′ after cutting outon the wafer W while lifting up the unnecessary tape T′.

When the separation unit 10 arrives at a separation completion position, the separation unit 10 and the joining unit 8 recede and return to the initial positions, respectively. Herein, the collection bobbin 20 winds the unnecessary tape T′ and the tape supply part 6 feeds out the adhesive tape T in a given amount.

When the forgoing tape joining operation is completed, the chuck table 5 releases the suction-holding of the wafer W. Then, the wafer holding part 2a of the robot arm 2 transfers the wafer W subjected to the tape joining process from the chuck table 5 to the wafer supply/collection part 1, and inserts the wafer W into the cassette C.

Thus, the series of operations, that is, a tape joining process is completed. Thereafter, the foregoing operations are performed on each new wafer in succession.

Herein, the number of times of the tape joining process is counted. Each time the tape joining process is completed by the predetermined number of times, a cutter blade cleaning process is executed as follows.

After the tape joining process has completed by the predetermined number of times, when the cutter blade 12 returns to the upper retracted position, the rodless cylinder 52 of the cutter blade cleaning device 50 is actuated. As shown in FIG. 12, this actuation allows the cleaning unit 56 in the retreat position (d) to move forward to the cleaning position (c).

When the cleaning unit 56 arrives at the cleaning position (c), the cutter blade 12in the upper retracted position is controlled so as to move downward. Then, the cleaning member 66 is pierced with the nose of the cutter blade 12 only by a predetermined depth. Thus, the adherent such as the adhesive adhering to the cutter blade 12 in the tape cutting process comes into contact with the wash liquid in the cleaning member 66, and is considerably reduced in adhesion to the cutter blade 12. In this state, when the cutter blade 12 moves upward, the adherent is wiped off by the cleaning member 66. It is assumed herein that the adherent can not be wiped off from the cutter blade 12. Also in such a case, when the cleaning member 66 is pierced with the cutter blade 12, the adherent is lifted up by the cleaning member 66 to an upper position of the cutter blade 12. Therefore, no adherent adheres to the cutting edge piercing through the cleaning member 66.

When the cutter blade 12 moves upward to the upper retracted position, the cleaning unit 56 moves from the cleaning position (c) to the receded position (d). This movement allows the container 59 to rotate only at the predetermined feed angle θ. In the next cutter blade cleaning process, when the cleaning member 66 is pierced with the cutter blade 12 at the cleaning position (c), the pierced position of the cleaning member 66 is different from the previous pierced position. In other words, each time the cutter blade cleaning process is executed, the pierced position of the cleaning member 66 with the cutter blade 12 is displaced.

In this case, the feed angle θ is set previously such that a value obtained by dividing an angle of 360° by the feed angle θ is not an integer. Thus, even when the cleaning member 66 rotates plural times, the cleaning process can be constantly performed in a new portion.

Moreover, each time the cleaning unit 56 returns to the receded position (d), the sensor 68 monitors the liquid surface level L of the wash liquid. Herein, the wash liquid is applied to the cutter blade 12 or evaporates, so that the liquid surface level L drops. If the liquid surface level L is detected to fall below a permissible range, the sensor 68 provides information to add the wash liquid. Accordingly, this configuration prevents such a disadvantage that the liquid surface level L drops and the wash liquid is short in a pierced region of the cleaning member 66 with the cutter blade 12.

It is preferable herein that the wash liquid exhibits a releasing property for suppression of adhesion of the adhesive when being applied to the cutter blade 12. Examples of the wash liquid may include a surfactant, a silicone-containing liquid, and any other liquids exhibiting a lubricating property and a releasing property. Depending on a type of an adhesive to be used herein, deionized water may be used as the wash liquid.

According to the foregoing embodiment, it is preferable that a water-soluble oil agent is used as the wash liquid in the case of cutting the surface-protective adhesive tape T joined to the wafer W. Specifically, the wafer W, to which the surface-protective adhesive tape T is joined, is washed with water in a back-grinding step. For this reason, even when the wash liquid applied to the cutter blade 12 adheres to and is left on the edge of the cut adhesive tape T, the water removes the wash liquid from the edge of the cut adhesive tape T together with abrasive powder in the back-grinding step. Accordingly, this configuration prevents such a disadvantage that the wash liquid, which adheres to and is left on the edge of the cut adhesive tape T, exerts an adverse influence in subsequent processing steps.

Herein, at the time when the cutter blade 12 moves downward to the cutting operation position, the degree of piercing the adhesive tape T with the cutter blade 12 is changed, so that the adhesive tape T can be cut with the cutter blade 12 having the cleaned cutting edge with higher cutting performance. It is preferable that such a degree is originally set to be large and then is reduced gradually each time the tape cutting process is executed. Herein, the adherent adhering to the cutter blade 12 gradually shifts toward the nose. Therefore, it is desirable that a piercing depth of the cutter blade 12 into the cleaning member 66 is gradually made shallow in the cutter blade cleaning process. With this configuration, even when the adherent cannot be wiped out completely in the cutter blade cleaning process, the cleaning member 66 pierced with the cuter blade 12 lifts up the adherent to an upper position of the cutter blade 12. Accordingly, when the cutter blade cleaning process is executed repeatedly while the piercing depth is gradually made shallow, the cleaning member 66 lifts up the adherent to a position where the adherent does not hinder the cutter blade 12 to cut the adhesive tape T. Thus, the cutter blade 12 can constantly cut the adhesive tape T in a favorable state.

In a region corresponding to the depth of the pierced position of the cleaning member 66 with the cutter blade 12, preferably, the liquid surface level is controlled such that the cutter blade 12 comes into contact with the wash liquid moderately. For example, if the liquid surface level is too high, the cutter blade 12 disadvantageously comes into contact with the wash liquid in a large amount. More specifically, in a case where the cutter blade 12 is heated in order to enhance the tape cutting performance, the temperature of the cutter blade 12 is decreased due to the contact with the wash liquid in the large amount, resulting in deterioration of the tape cutting performance. Moreover, the contact of the cutter blade 12 with the wash liquid in the large amount causes the following disadvantage. That is, since the wash liquid drops on the cutter blade 12 when the cutter blade 12 is pulled out of the cleaning member 66, an ambient environment may be contaminated by this wash liquid.

Herein, the support arm 55 that supports the cleaning unit 56 is attached to the movable table 54 such that a position thereof can be changed in a direction orthogonal to the moving direction of the movable table 54. Accordingly, when the position of the cutter unit 23 is changed with respect to the vertical axis X in accordance with the change in size of the wafer W, the attachment position of the support arm 55 is changed in correspondence with this change. This attachment position is adjusted such that the cleaning member 66 is located on or out of the liftable movement path of the cutter blade 12. Further, the position of the feed claw 72 is also adjusted in correspondence with this change.

In addition to the foregoing embodiment, the present invention may be embodied variously as follows.

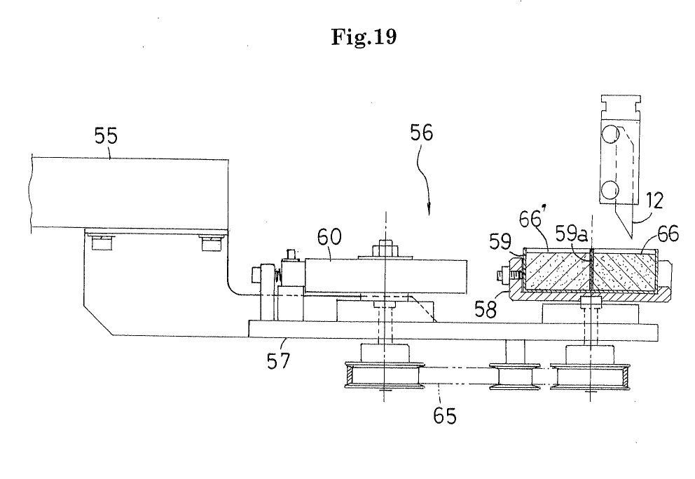

(1) As shown in FIG. 19, the container 59 is divided into two segments, that is, a front segment and a rear segment by a partition wall 59a. The front segment houses a cleaning member 66 which is used only for wash and is impregnated with only a wash liquid. On the other hand, the rear segment houses a cleaning member 66′ which is impregnated with a release agent such as oil. In this configuration, first, the cleaning member 66 housed in the front segment is pierced with the cutter blade 12 in order to remove the adherent from the cutter blade 12. Then, the cutter blade 12 is pulled out of the cleaning member 66, and the cleaning unit 56 slightly moves forward/backward such that the rear segment of the container 59 faces the lower side of the cutter blade 12. Thereafter, the cutter blade 12 moves downward, and the cleaning member 66′ housed in the rear segment is pierced with the cutter blade 12 in order to apply the release agent to the nose.

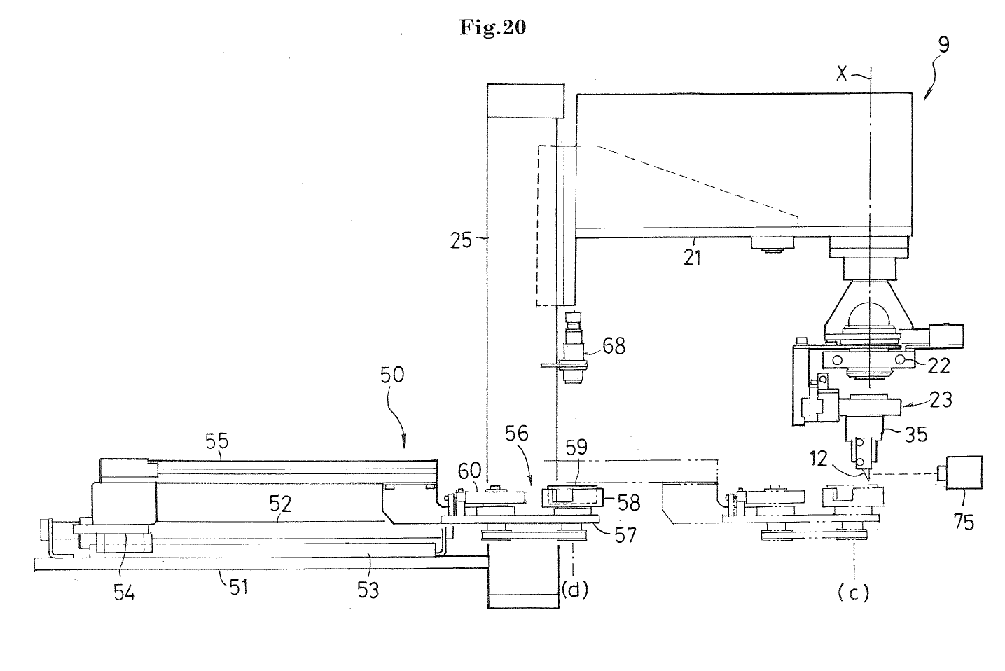

(2) As shown in FIG. 20, moreover, a surveillance sensor 75 such as a CCD camera or a reflective laser sensor can be installed so as to face the cutter blade 12 located at the upper retracted position. An operator checks the adherent adhering to the cutter blade 12 through use of the surveillance sensor 75. That is, the foregoing cutter blade cleaning process can be executed only when the adherent in an amount exceeding a preset amount adheres to the cutter blade 12. This configuration eliminates unmeaning execution of the cutter blade cleaning process in a state where no adherent adheres to the cutter blade 12 or in a state where the adherent adhering to the cutter blade 12 is considerably small in amount.

Moreover, the operator monitors the cutter blade 12 after execution of the cutter blade cleaning process to check whether or not the adherent is still left on the cutter blade 12. If the adherent left on the cutter blade 12 is large in amount, the cutter blade cleaning process may be executed again. Further, the surveillance sensor 75 may detect chipping of the cutting edge of the cuter blade 12 to provide information about a timing of exchanging the cutter blade 12 to the operator.

(3) In a case where an adhesive tape T to be used herein has an adhesive which readily adheres to the cutter blade 12, the cutter blade cleaning process may be executed every time after completion of the tape cutting process.

(4) The cleaning member 66 is not particularly limited as long as it can be impregnated with a wash liquid. For example, a felt-like cleaning member may be used in addition to the foregoing sponge-like cleaning member. In addition, a brush-like cleaning member including a plurality of thin bristles may be used. In a case where an adhesive to be used herein is high in adhesion strength, preferably, a cleaning member to be used herein contains an abrasive.

(5) In the adhesive tape joining apparatus according to the present invention, the rotation of the container 59 allows the displacement of the pierced position of the cleaning member 66 with the cutter blade 12. Alternatively, a piercing angle of the cutter blade 12 may be changed.

In this case, the air cylinder 39 rotates the operation flange 38 of the cutter unit 23 to change the position of the entire cutter unit 23 about the vertical axis Y with respect to the support arm 22. Thus, the piercing angle of the cutter blade 12 into the cleaning member 66 can be changed. Accordingly, the rotation of the container 59 and the change in piercing angle of the cutter blade 12 allow efficient use of the cleaning member 66.

The present invention may be embodied in other specific forms without departing from the spirit or essential attributes thereof and, accordingly, reference should be made to the appended claims, rather than to the foregoing specification, as indicating the scope of the invention.

What is claimed is:

1. A cutter blade cleaning method for cleaning a cutter blade that cuts out an adhesive tape, which is joined to a substrate, along a contour of the substrate, the cutter blade cleaning method comprising the step of
executing a process of cleaning an adherent from the cutter blade while displacing a pierced position of a cleaning member with the cutter blade.

2. The cutter blade cleaning method according to claim 1, wherein
each time the cleaning member is pierced with the cutter blade, the piercing depth is gradually made shallow.

3. The cutter blade cleaning method according to claim 1, wherein
the cleaning member is impregnated with a wash liquid.

4. The cutter blade cleaning method according to claim 3, wherein
the wash liquid has a releasing property for anti-adhesion.

5. The cutter blade cleaning method according to claim 1, wherein
the cutter blade pierces through a first cleaning member impregnated with a wash liquid and then pierces through a second cleaning member impregnated with a release agent for anti-adhesion.

6. The cutter blade cleaning method according to claim 1, wherein
the adherent adhering to the cutter blade is monitored by a surveillance sensor.

7. The cutter blade cleaning method according to claim 6, wherein
when the adherent adhering to the cutter blade is detected by the surveillance sensor, the cleaning member is pierced with the cutter blade newly and the pierced position of the cleaning member with the cutter blade is displaced.

8. A cutter blade cleaning device for cleaning a cutter blade that cuts out an adhesive tape, which is joined to a substrate, along a contour of the substrate,
the cutter blade cleaning device comprising:
the cutter blade that is disposed so as to move liftably between an upper retracted position and a lower cutting operation position; and
a cleaning member that moves between a cleaning position on a liftable movement path of the cutter blade and a receded position out of the liftable movement path, wherein
the cleaning member and the cutter blade are moved relatively such that a pierced position of the cleaning member with the cutter blade is displaced.

9. The cutter blade cleaning device according to claim 8, wherein
the cleaning member rotates about the pierced position thereof with the cutter blade, with the pierced position being defined as a starting point.

10. The cutter blade cleaning device according to claim 9, further comprising
a ratchet type pitch feed device for allowing the cleaning member to rotate at a predetermined angle in conjunction with the movement of the cleaning member from the cleaning position to the receded position.

11. The cutter blade cleaning device according to claim 8, wherein
the cleaning member is impregnated with a wash liquid.

12. The cutter blade cleaning device according to claim 11, further comprising
a container that is divided into two segments by a partition wall, wherein
a first segment of the container houses the cleaning member impregnated with the wash liquid while a second segment of the container houses a cleaning member impregnated with a liquid having a releasing property.

13. The cutter blade cleaning device according to claim 11, further comprising:
a sensor that detects a liquid surface level of the wash liquid retained in a container in which the cleaning member is housed while being impregnated with the wash liquid;
a calculation device for comparing an actually measured value of the detected liquid surface level with a predetermined reference value; and
an informing device for providing information when the actually measured value falls below the reference value as a result of the comparison between the actually measured value and the reference value.

14. An adhesive tape joining apparatus comprising:
a chuck table that holds a substrate placed thereon;
a tape supply device for supplying a surface-protective adhesive tape above the substrate placed on and held by the chuck table, with an adhesive surface of the adhesive tape being directed downward;
a joining roller that rolls on the adhesive tape while pressing the adhesive tape against the substrate to join the adhesive tape to the substrate;
a tape cutting device that allows a cutter blade, which moves liftably, to relatively travel along an outer periphery of the substrate in a state where the adhesive tape joined to the substrate is pierced with the cutter blade;
a separation roller that separates an unnecessary tape occurring from the tape cutting and collects the unnecessary tape; and
a cleaning member that moves between a cleaning position on a liftable movement path of the cutter blade and a receded position out of the liftable movement path, wherein
the cleaning member and the cutter blade are moved relatively such that the pierced position of the cleaning member with the cutter blade is displaced.

15. The adhesive tape joining apparatus according to claim 14, wherein
the cleaning member rotates about the pierced position thereof with cutter blade, with the pierced position being defined as a starting point.

16. The adhesive tape joining apparatus according to claim 15, further comprising
a ratchet type pitch feed device for allowing the cleaning member to rotate at a predetermined angle in conjunction with the movement of the cleaning member from the cleaning position to the receded position.

17. The adhesive tape joining apparatus according to claim 14, wherein
the cleaning member is impregnated with a wash liquid.

18. The adhesive tape joining apparatus according to claim 17, further comprising
a container that is divided into two segments by a partition wall, wherein
a first segment of the container houses the cleaning member impregnated with the wash liquid while a second segment of the container houses a cleaning member impregnated with a liquid having a releasing property.
